(19) United States
(12) Patent Application Publication
(10) Pub. No.: US 2014/0287391 A1
(43) Pub. Date: Sep. 25, 2014

(54) METHOD AND SYSTEM FOR TRAINING ATHLETES

(71) Applicant: Curt Krull, Orange City, IA (US)

(72) Inventor: Curt Krull, Orange City, IA (US)

(21) Appl. No.: 14/298,375

(22) Filed: Jun. 6, 2014

Related U.S. Application Data
(63) Continuation-in-part of application No. 14/026,555, filed on Sep. 13, 2013.
(60) Provisional application No. 61/831,794, filed on Jun. 6, 2013.
(60) Provisional application No. 61/700,563, filed on Sep. 13, 2012.

(51) Int. Cl. A63B 69/00; A63B 71/06; G09B 5/02

(52) U.S. Cl. CPC A63B 69/00; G09B 5/02; A63B 71/0622
USPC 434/247; 473/422

(57) ABSTRACT

A method and system is provided for training athletes using films or videotapes of game situations so that a player's reaction can be applied to such situations. The videos are taken from the player's eye-level perspectives on the field or court. The method and system can be used for various sports, including basketball, football, baseball, hockey, soccer, volleyball, wrestling, and any other sport, particularly team sports. Using this system and method of the present invention will enhance and expedite training of athletes.

### CROSS-REFERENCE TO RELATED APPLICATIONS

This application claims priority under 35 U.S.C. §119 to provisional application Ser. No. 61/831,704 filed Jun. 6, 2013, herein incorporated by reference in its entirety. This application is also a continuation-in-part of co-pending application Ser. No. 14/026,555 filed Sep. 13, 2013, which claims priority under 35 U.S.C. §119 to provisional application Ser. No. 61/700,563 filed Sep. 13, 2012, all of which are incorporated by reference in their entirety.

### FIELD OF THE INVENTION

The present invention relates to a method and system for training athletes at all levels and capabilities in various sports, including basketball, football, baseball, hockey, soccer, volleyball, wrestling, and nearly any other sport requiring visual analysis of a play or game situation and a reaction by the athlete to the situation.

The present invention allows the athlete to improve and develop his/her performance using visual recognition (stimuli to recognize and understand) of game situations and the ability to interact with or manipulate a game play video in order to maximize physical performance based upon those visual circumstances.

For purposes of this application, “training” means both teaching and testing the user athlete.

### BACKGROUND OF THE INVENTION

Video training for athletes and players has now become as crucial as their physical training. In fact, the physical part of the contest or play is largely, or at times entirely dependent upon the participant's visual recognition of the situation or circumstance and his mental training to react to that visual stimuli. Recognition of specific situations and circumstances and the proper understanding of those situations and circumstances will often spell the difference between success and failure.

Historically, coaches have used conventional video training that involves elevated views of the entire field or court from either the side or from behind the play or activity. Unfortunately, these views are passive, with little if any interaction, and do not depict what the athlete actually sees during a game or contest. Recently, coaches have realized that video from the player's perspective is a good training tool. They have been experimenting with cameras attached to the player to see what the player sees, but these cameras restrict the coach to what the player is looking at and the video is often jumpy and hard to watch.

Therefore, there is a need for improved training methods and systems which will enhance the teaching and training process of the athletes.

Accordingly, a primary objective of the present invention is the provision of a method and system of training athletes or players using video recorded from the player's normal eye level positions or perspective on the field, court or venue of play.

Another objective of the present invention is the provision of a method and system of training athletes using two or more screens of game or practice video, one being the interactive video, filmed from the athlete's eye level perspective that can be manually manipulated according to specific training needs and game or contest situations.

A further objective of the present invention is use of synchronized recordings of a play from multiple players' perspectives.

Another objective of the present invention is the provision of a method and system for training players using a computer and software program which includes numerous plays videotaped from the player's eye level vantage point on the playing surface, so as to learn and understand reactions and options to specific plays.

Another objective of the present invention is the provision of a method and system for training athletes using a computer and software program which includes numerous plays filmed from the athlete's eye level during a practice, game or contest so as to be taught and tested on various game situations and circumstances.

Yet another objective of the present invention is the provision of software which allows selection of play video from multiple players on-the-field/court positions, display of the selected plays from single or multiple positions, addition of drawings and notes on the selected plays, addition of voice overs, and management of a collection of plays in one or more digital folders.

### SUMMARY OF THE INVENTION

Embodiments of the invention include interactive video that presents the view of an athletic play, match, activity, or situation from eye level or near eye level, such as immediately above the head of the athlete or competitor. “Video” and “videotape” are used generically in this application to cover any and all means for recording the play or activity to be used for training the athlete. “Play” is used generically to mean any athletic activity on any venue, indoors and outdoors, such as a field, court, mat, or other surfaces. Film of the play or athletic event is shot with a camera using a wide angle lens that will capture the entire playing field or court. The video is then imported into software that presents the play in a format that allows the user to move the screen or view from side to side with a mouse, touch screen, finger slide, or similar process, much like the athlete would do with his head or eyes on the field or court. The user can move the view or screen from side to side while the action is going on or the action can be paused and the screen or view moved to another angle. The user can also zoom in or out depending on the need for analysis or simulation to the actual live experience of the play. The ability to move views of actual live plays or athletic events whenever and wherever the user desires literally replicates the visual experience on the field or court and creates a new mental experience every time the video is used on the computer interface.

This interactive video is then combined with one or more additional views such as team activity filmed from the conventional elevated vantage points or other player activity filmed from eye-level. All videos are synchronized giving the user multiple views of the same play at the same time. Videos can be organized and presented in any method or manner desired by the user. The invention also incorporates written instruction and a location for notes so that the player can learn by using the software even when the coach is not around. Voice over comments and directions can also be added by the coach or player.

Thus game or contest situations can be created making this invention a dramatic improvement as a video teaching and testing tool. This invention offers the option of combining the old elevated views that coaches are presently using with the innovative video software showing the play or situation from the player's or players' perspective(s). The innovative software allows the user to control or manipulate the view from eye-level to create a new visual experience every time the video is watched, similar to being on the field anew each time. For example, the athlete or coach can manipulate the view, to move the play in any direction, such as left or right, and zoom in or out on the play. The interactive use of the technology by the player improves and hastens the learning process, as compared to traditional passive viewing of game film.

The invention is a dramatic improvement over the old or present system of coaching with video. First, the conventional elevated videos cannot show what the player actually sees. Second, a helmet camera video from an athlete that must scan large areas is very limited because it is jumpy and often times out of focus. It only shows what the player is looking at and that is a disadvantage when the player is looking in the wrong direction. Helmet cams cannot zoom in and out and cannot pause and then look to another part of the field or court.

Helmet cams and elevated team views can, however, be useful video tools when used in conjunction with this invention's innovative software and video. A larger all-encompassing team picture is an important coaching video tool to give the coach the “big picture” of the play. A helmet cam of a teammate participating in the same play as the player whose view is shot with the innovative software can also be an important part of the entire video teaching process. Thus, by combining all of these video options, on one interface screen, the coach and players can maximize their video learning process heretofore not possible.

Another unique feature or aspect of the present invention is internet teaching capabilities. Because of the ability to record, control and manipulate eye-level actual video, there is an expanded ability for teaching and testing athletes that doesn't exist with just elevated team views or even helmet cams alone. Every user's manipulation and control of the innovative video is unique unto him or her. Therefore, each time the video is used, a new experience occurs, just like on the field. Just like no two plays are performed exactly alike on the field, each user's movement of the screen and visual concentration will be unique. Yet, the play itself will remain the same so that coaches and players can now share the same eye-level view of the same play and share ideas, coaching points and performance comparisons. In other words, Coach A, in New York, can view the same play with his quarterback as Coach B and his quarterback in California. The coaches can share information and coaching points while their respective quarterbacks learn from the same play at different speeds and learning curves.

Finally, the present invention is a big improvement over teaching tools that use computer animation and graphics. First, based upon well-established educational principles, visual depictions of actual events is the best learning tool the human brain can have. Second, filming or videotaping plays will automatically capture the size and speed of the athletes at the level being filmed. There is no need to program these variables to fit the player or user's age or experience. Third, and perhaps most importantly, the interactive video will accurately depict what the player or athlete saw during the game or practice so as to replay the visual experience in the user's mind thus providing unlimited opportunities to repeat the real life experience. This cannot be done with animation since the play is locked into the same process over and over again and will almost never actually duplicate what happened live on the field or court.

### BRIEF DESCRIPTION OF THE DRAWINGS

FIG. 1 shows an example of a screen shot of a computer monitor using the software of the present invention wherein multiple views of the same play from different perspectives are provided.

FIGS. 2-5 show alternative screen layouts with multiple views of a play from different perspectives on the court of field.

FIG. 6 is a block diagram of one example of a system used to implement the invention.

FIG. 7 is a flow chart illustrating one example of a use of the invention.

### DETAILED DESCRIPTION OF THE PREFERRED EMBODIMENTS

The method and system of the present invention is intended for use in training athletes using films or videotapes of game situations so that a player's reaction can be applied to such situations. The videos are taken from the player's eye-level perspectives on the field or court. The method and system can be used for various sports, including basketball, football, baseball, hockey, soccer, volleyball, wrestling, and any other sport, particularly team sports. Using this system and method of the present invention will enhance and expedite training of athletes. For the purposes of this description, examples of a system used in training football players will be used. It should be understood that these are merely examples, and that the concepts described may apply to any desired sport.

The method and system of the present invention is intended for use in training the mental aspects of game participation for athletes using actual live game or practice footage from the athlete's on-the-field or court eye level position or as nearly as possible from the athlete's perspective. The videos are taken from either a stationary camera located just above an athlete's head or a miniature camera positioned on the athlete's head or helmet at approximately the athlete's eye level. The method and system can be used for any sport that requires a player to recognize specific game, contest or competitive situations and then act according to a planned or coached response. Using this system and method of the present invention will enhance and expedite the learning process and reduce preparation time for athletes in various sports.

### Filming

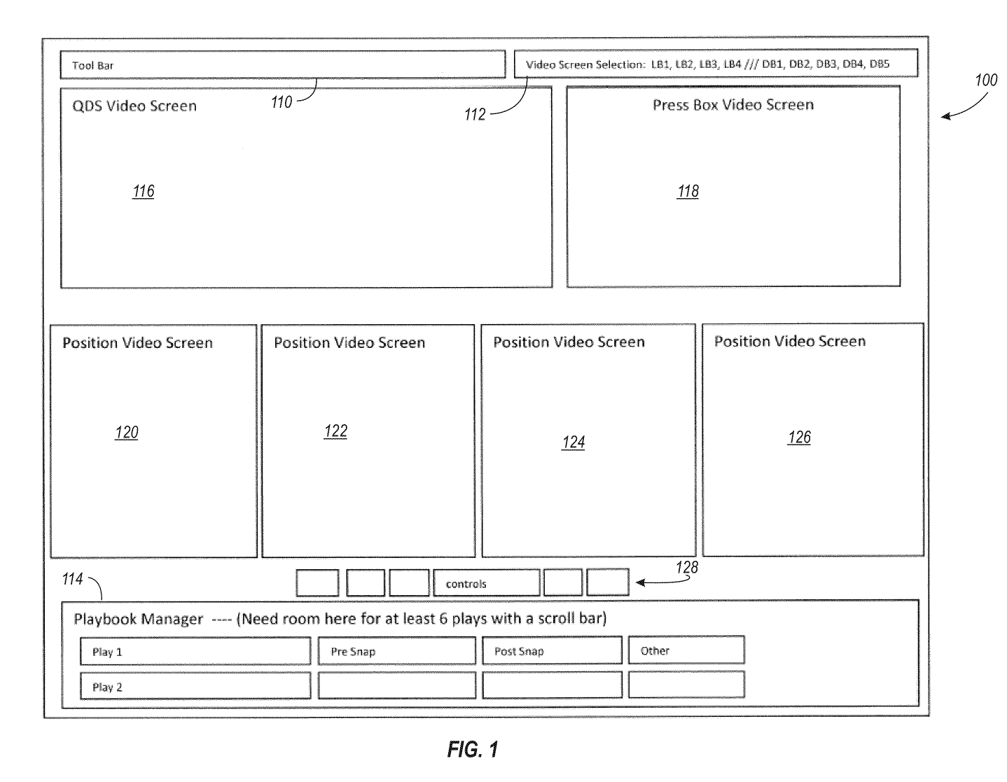

In some embodiments, multiple views of each play or game situation are shot from cameras placed behind one player, such as the quarterback, on the heads of his teammates, such as the receivers, and from the conventional elevated shots from the side or behind the play. The videotaped plays are then downloaded to a computer, tablet or other processor using a software program for later viewing by one or more players and/or coaches. Alternatively, the plays can be accessed through a link to another Internet site where the plays are stored. The plays (or other data) can be stored in any manner desired, whether local, remote, such as in a computer, on a server, on a cloud server, etc. The trainee athlete or his/her coach can select from the available plays. Each selected play will be presented on the computer monitor from the player's or players' perspective(s), as shown in the example of FIGS. 1-5. The examples shown in figures are described in more detail below. The trainee can pause and play the game action, as desired, so as to view the play from different perspectives. The trainee can also enlarge any of the perspectives to a full screen. The partial screen and full screen plays can be paused, and then forwarded or reversed frame by frame. The trainee can analyze the selected play to learn various options for specific game situations. Different play situations can be sequentially viewed by the trainee, thereby developing the trainee's understanding of the different game situations.

For example, a quarterback, soccer goalie, or hockey goalie must be able to scan the entire width of the field at any particular time before or during a play. Therefore, a small wide angle (for example, 180 degrees) video camera is positioned as closely to the head position of the player as possible. Additional miniature cameras can be attached to the heads or helmets of any number of additional teammates. The videotaped plays are then downloaded to a computer, tablet or other processor using a software program for later viewing by the athlete or his coach. Alternatively, the plays can be accessed through a link to another Internet site where the plays are stored. The athlete or coach can select from the available plays.

### Teaching

Each selected play will be presented on the computer monitor from two or more camera views as shown in FIGS. 1-5 (described in more detail below). The athlete or coach can pause and play the game action, as desired, so as to view the play from multiple perspectives all at the same time in synchronized fashion. The user can enlarge any of the perspectives to a full screen. The partial screen and full screen plays can be paused, and then forwarded or reversed frame by frame. The user can analyze the selected play to see whether he or she understands the pre-play and post-play action and whether the right decisions are being made in a timely manner. Different plays can be sequentially viewed by the user to fit different game situations and circumstances thereby developing the user's ability to efficiently recognize those situations and circumstances.

Viewing options for players and coaches include (but are not limited to):
Interactive view only on one screen—Interactive video can be applied to the video taken from a stationary point behind a selected player or even to the helmet or head cam shots on the heads of other players or teammates
Synchronized interactive view plus one or more elevated team shots
Synchronized interactive view plus one or more helmet or head cams from players/teammates
Synchronized interactive view plus an elevated team view and a helmet or head cam from a player/teammate
Synchronized view of all player helmet or head cams
Synchronized view of any combination of player helmet or head cams and elevated team shots
Any other desired combination of views, play diagrams, etc.

The viewing monitor may also include areas for the user to add notes or comments or superimposed on the video screens themselves. In addition, lines or symbols may be drawn or placed on the video screens for teaching emphasis. Finally, the coach can apply “voice over” instructions for the athlete and can even make “canned” instruction for mass distribution or for annual instruction to different levels of competition. For example, a coalition of coaches could produce a series of videos that are interactive and combined with voice over instruction. Or, a coach could produce a series of interactive videos with voice over instruction for his youth or junior high players. These younger players could then learn from these interactive videos with minimal participation by the coach.

### Testing

Ideally, an athlete should must recognize play situations and circumstances and then react as quickly as possible. Therefore, this invention includes a testing process to enhance and expedite the reaction times for the athletes.

Plays are selected to be presented to the athlete on one large full screen with a generic name as “Play 1” or “Play 2”. The user will select a play and then begin the test process. He or she must then go through the specific mental steps of explanation, identification, recognition and appropriate responses, all within time steps. For example, in the football software, a quarterback is asked to explain a specific play, recognize and identify the pre-snap or pre-play opponent situation, recognize and identify the opponent situation once the play has begun, recognize and identify his first, second and possibly third receiver options during the play, and then get his feet and body in position to throw the ball when the receiver will be open. The user can perform this test from either a sitting position or standing in front of a large screen and physically performing his/her part of the play.

Prior methods of teaching the mental aspects of game performance involved either video from remote positions such as press box or end zone angles and/or computer generated players against a computer background to provide the eye-level view of a player. Applicant's invention is a marked improvement from those methods for two reasons:
1) Because actual video of a game or practice is being used and it is from the eye-level of the participant, any subsequent user of the video can get the same game or practice feel and situation as the person who was involved in the process initially. Actual events can literally be relived or experienced over again.
2) There is no need to program player sizes, speed and reaction as is required in computer generated programs. The video captures the level of performance applicable to the user automatically. If the video is taken of youth football, the players involved have the size and speed of youth football. If the video is taken of a professional team, the players will have the size and speed of that level.
   This training tool is built upon two open source LFPL licensed third party libraries: The Qt Tool Kit (http://qt.nokia.com) and Toadlet Engine (http://code.google.com/p/toadlet). A video library is built on top of these tool kits, with the library containing all of the functionality for the applications, including video conversion and playback, image loading, playbook management, user interface elements, and more.

In some examples, the various sports to which the method and system of the present invention apply will generally include the following common features:
Video files may be loaded from a wide variety of different formats and sizes;
All videos are converted into a common format when loaded;
Multiple videos may be synchronized and played together;
Individual videos and diagrams may be displayed in full screen mode;
Videos may be displayed and played on arbitrary curved surfaces;
View navigation can be provided to observe curved video from different orientations;
Still images may be loaded and displayed;
Drawing may be performed on a layer on top of the videos or still images;
Any combination of videos and/or images may be added;
Textual notes may be added and stored;
Voice over may be added;
Plays may be organized into a series of folders;
An exam mode may be run which tests the trainee's or user's knowledge of plays, formulations, rules and more.

Thus, once the plays are videotaped and downloaded onto a computer using the software or otherwise stored for accessibility of use, various teaching and test modes can be utilized for the training of athletes. The method and system of the present invention teaches the plays and measures comprehension of the play situations and various optional reactions by the players, while allowing the user to manage the play books. The videos can be paused for review and/or discussions of many different game situations.

The videos, taken from the player's perspective or position on the playing venue allow the training sessions to be conducted without being on the court or field. The videos or combinations of videos can be organized in any desired manner, such as different files corresponding to different rules, situations, concepts. Trainers and/or trainees can add digital or electronic notes to specific plays or folders, as well as voice over instructions and comments. Use of this method and system trains an athlete to recognize game situations more quickly and accurately.

As mentioned above, FIGS. 1-5 show several examples information that can be displayed on a monitor. Other examples are also possible, as desired. FIG. 1 shows a monitor or screen 100 divided into several sections. The various sections are able to present videos, play diagrams, tool bars, menus, controls, etc. In this example, FIG. 1 shows a tool bar 110 that can include any desired menu items for controlling and configuring the program. A video screen selection menu 112 allows a user to select various video screens. A playbook manager 114 allows a user to select any desired plays to show on the various video screens. A first video screen 116 is shown as a quarterback development system (QDS) screen, which is a view from the perspective of a quarterback via a wide angle (e.g., 180 degrees) camera positioned behind the quarterback. As described above, a user is able to use a mouse to zoom, pan, rotate, etc. this view due to the wide angle lens. Video screen 118, in one example, is a press box video screen, which shows the field of play from the perspective of a press box, i.e., an overhead view. FIG. 1 also shows position video screens 120, 122, 124, and 126. Position video screens show the play from the perspective of any desired player position. For example, for a football play, a position video screen may show the play from the perspective of a lineman, receiver, running back, defensive player, etc. Any of the sections of screen 100 can also show a diagram of the selected play. FIG. 1 also shows controls 128, which may include video playback controls, for example.

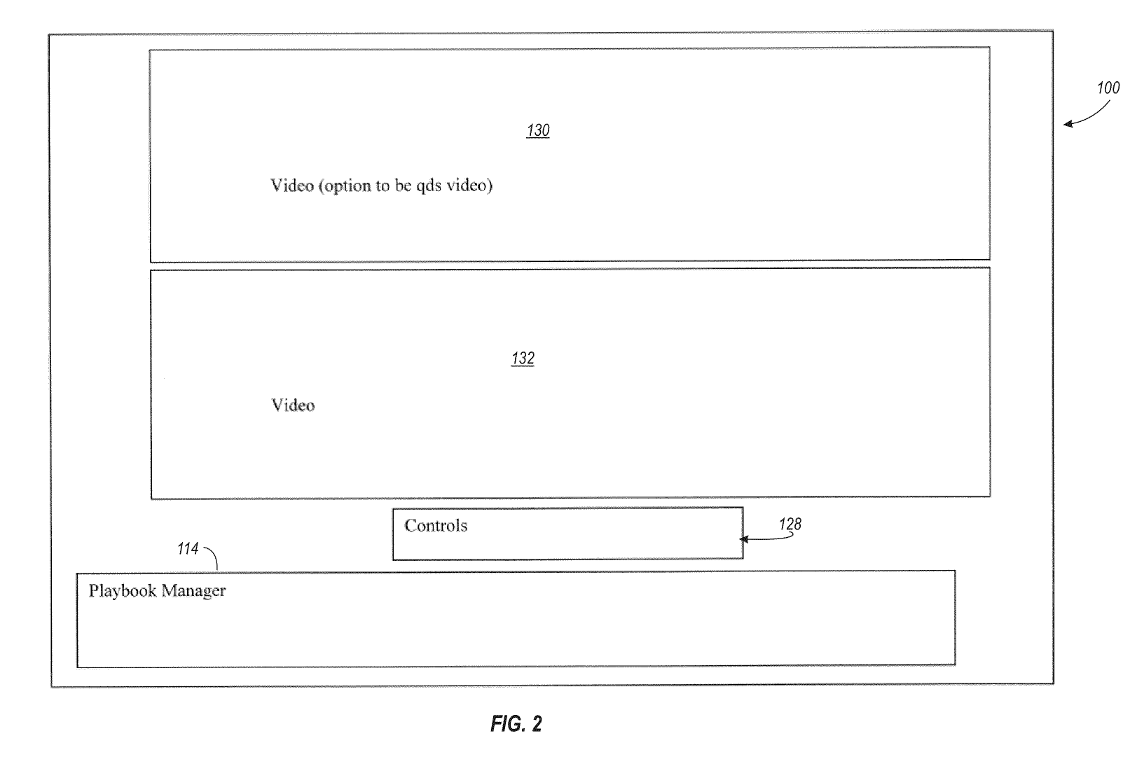

FIG. 2 shows another example of a monitor or screen 100 divided into several sections. In this example, the screen 100 shows the controls 128 and playbook manager 114 similar to that shown in FIG. 1. In this example, a user has configured the screen 100 to show two enlarged video screens 130 and 132. The video screens 130 and 132 can show any desired video (e.g., QDS video screen, press box video screen, position video screen, play diagram, etc.).

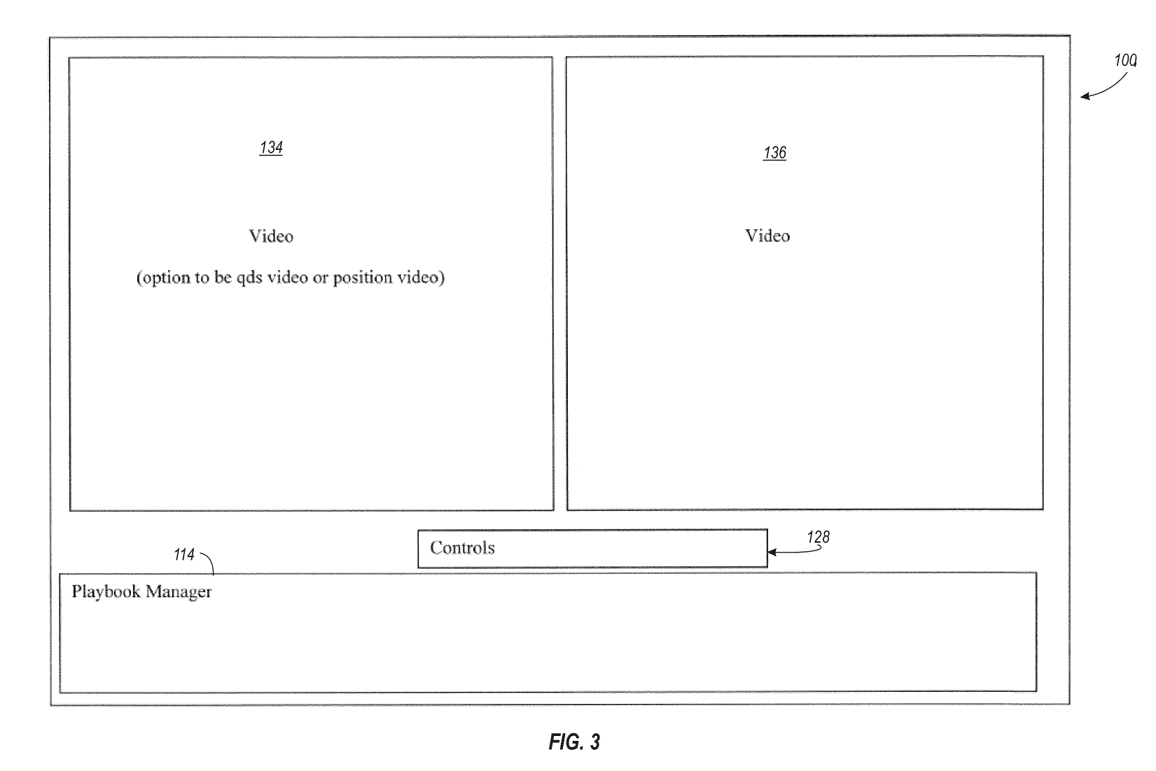

FIG. 3 shows another example of a monitor or screen 100 divided into several sections. In this example, the screen 100 shows the controls 128 and playbook manager 114 similar to that shown in FIGS. 1 and 2. In this example, a user has configured the screen 100 to show two enlarged video screens 134 and 136 side-by-side. The video screens 134 and 136 can show any desired video (e.g., QDS video screen, press box video screen, position video screen, play diagram, etc.).

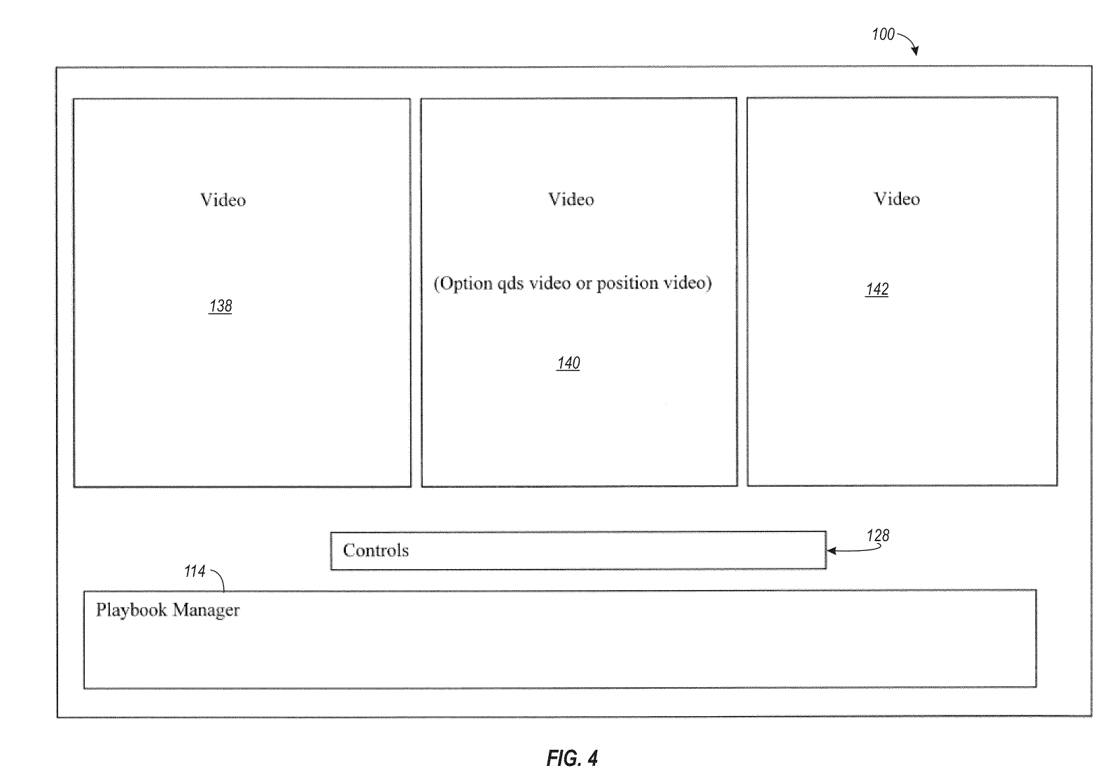

FIG. 4 shows another example of a monitor or screen 100 divided into several sections. In this example, the screen 100 shows the controls 128 and playbook manager 114 similar to that shown in FIGS. 1-3. In this example, a user has configured the screen 100 to show three enlarged video screens 138, 140, and 142 side-by-side. The video screens 138, 140, and 142 can show any desired video combinations (e.g., QDS video screen, press box video screen, position video screen, play diagram, etc.).

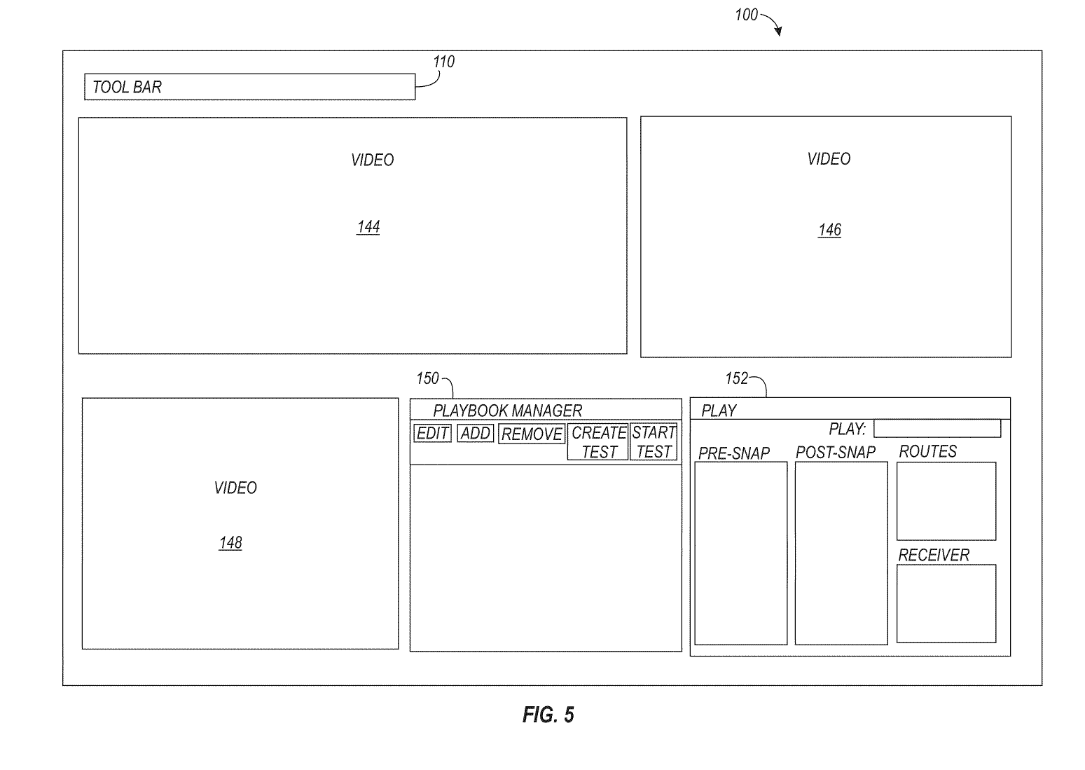

FIG. 5 shows another example of a monitor or screen 100 divided into several sections. FIG. 5 shows an example of a screen that a user may use to configure and conduct a training process. The screen 100 is configured to show three video screens 144, 146, and 148. As before, the video screens 144, 146, and 148 can show any desired video combinations. In one example, video screen 144 is configured to show an eye-level interactive view. In the example of a football application, the eye-level interactive view is from a stationary camera having a wide angle lens, positioned behind the quarterback. The user is able to “pan” left and right, within the range of the wide angle lens. Video screens 146 and 148 show additional views of the same play. This enables a user to capture the play as a player sees it on the field. The screen 100 also adds classroom instruction in the same visual experience via blocks 150 and 152. FIG. 5 shows a playbook manager block 150 that includes menu buttons for EDIT, ADD, REMOVE, CREATE TEST, and START TEST. These menu buttons allow a user to select plays, configure a testing process, as well as administer a test. Block 152 shows a window that includes fields for pre-snap and post-snap items, the selected play, routes, and receivers. As described above, the screen 100 is configurable by the user, for example, allowing the user to view any of the video screens in full screen mode.

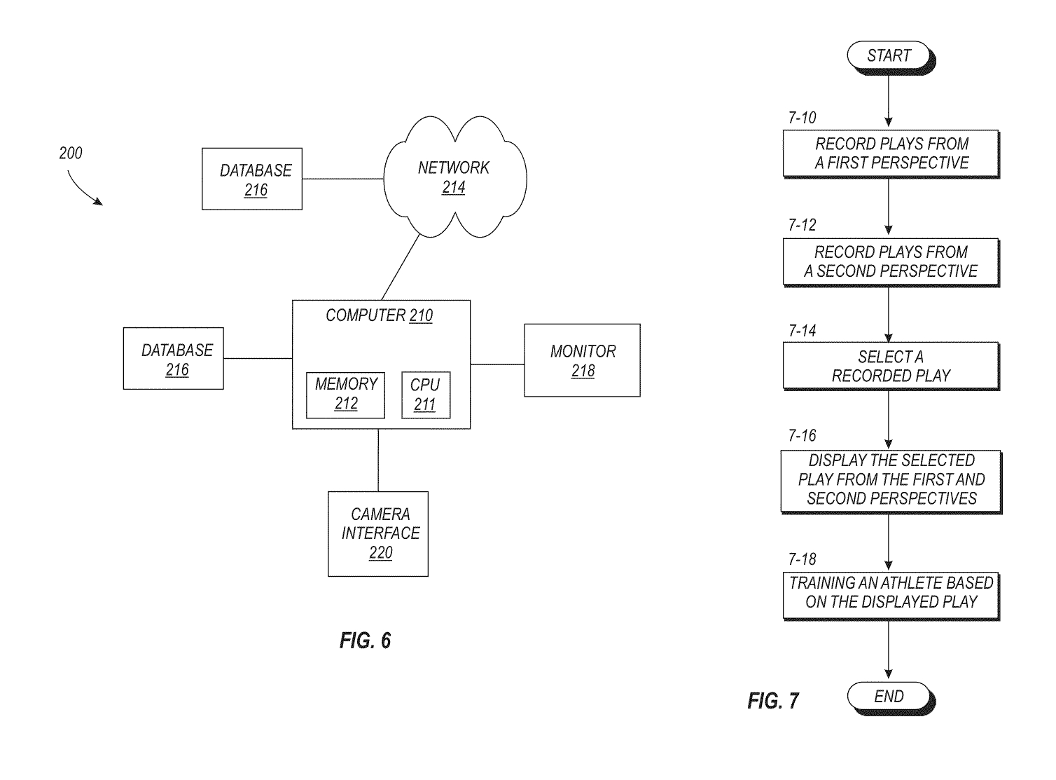

A program implementing the invention can run on any desired platform, including a computer, tablet, smart phone, etc. FIG. 6 is a block diagram of one example of a system 200 used to implement the invention. Other examples are also possible. The system 200 includes a computer 210 having a CPU 211 and memory 212. The computer 210 may be a PC, tablet, smart phone, etc. The computer 210 is shown connected to an optional network 214, which may be a LAN, WAN, Internet, etc. One or more databases 216 are in communication with the computer 210, either directly, or over the network 214. The computer 210 has one or more monitors 218. An optional camera interface 220 allows a user to upload recorded video to the computer 210. The camera interface 220 may be USB, WiFi, Bluetooth, Ethernet, or any other desired type of interface.

FIG. 7 is a flow chart illustrating one example of one use of the invention. At step 7-10, a sports play is recorded from a first perspective. In the example of a football play, the first perspective may be the perspective of a quarterback. In one example, the first perspective is recorded via a stationary camera with a wide angle lens positioned behind the quarterback. At step 7-12, the same play is recorded from a second perspective. In one example, the second perspective may be an overhead view, for example from a press box. In another example, the second perspective may be from another player, for example, from a helmet camera. At step 7-14 a user of the system selects a recorded play. At step 7-16, the selected play is displayed on the computer monitor from the first and second perspectives. The videos from each perspective are synchronized with each other. Note that other information, as well as additional perspectives, may also be displayed. At step 7-18, an athlete is trained based on the displayed play.

This invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, touch pad, etc.), or the like. In embodiments of the invention, the computer has access to at least one database over the network.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

What is claimed is:

1. A method of training athletes, comprising:
recording sporting plays at a sports venue from a first perspective of a first player at the venue;
recording the plays from a second perspective of a second player at the venue;
the recording from the first and second perspectives being synchronized;
selecting one of the recorded plays for viewing on a monitor by an athlete being trained;
displaying the selected play from the first and second perspectives on the monitor; and
training the athlete based on the displayed play.

2. The method of claim 1, wherein the recording is made using a stationary camera positioned behind the first player.

3. The method of claim 1, wherein the first and second perspective plays can be simultaneously viewed on the monitor by the athlete.

4. The method of claim 1, wherein training is provided for athletes selected from a group of sports including football, basketball, baseball, soccer, hockey, volleyball, and wrestling.

5. The method of claim 1, further comprising providing videos of each play from multiple player on-the-venue perspectives.

6. The method of claim 5, further comprising viewing the multiple perspectives of each play simultaneously on the monitor.

7. The method of claim 1, further comprising allowing the athlete to selectively pause a selected play.

8. The method of claim 7, further comprising reviewing the selected play frame by frame.

9. The method of claim 1, further comprising recording the play from an elevated position and displaying the elevated recording on the monitor.

10. A computer program product comprising at least one non-transitory computer readable medium storing instructions translatable by at least one processor to perform:
allowing a user to select a pre-recorded sporting play for viewing on a monitor by an athlete being trained, the pre-recorded sporting play being recorded at sports venue from a first perspective of a first player at the venue and from a second perspective of a second player at the venue, the recordings from the first and second perspectives being synchronized;
displaying the selected sporting play from the first perspective of the first and second perspectives on the monitor; and
training the athlete based on displayed play.

11. The computer program product of claim 10, wherein the pre-recorded plays are recorded by a stationary camera positioned behind the first player.

12. The computer program product of claim 10, further comprising allowing the first and second perspective plays to be simultaneously viewed on the monitor by the athlete.

13. The computer program product of claim 10, wherein training is provided for athletes selected from a group of sports including football, basketball, baseball, soccer, hockey, volleyball, and wrestling.

14. The computer program product of claim 10, further comprising providing videos of each play from multiple player on-the-venue perspectives.

15. The computer program product of claim 14, further comprising viewing the multiple perspectives of each play simultaneously on the monitor.

16. The computer program product of claim 10, further comprising allowing the athlete to selectively pause a selected play.

17. The computer program product of claim 16, further comprising reviewing the selected play frame by frame.

18. The computer program product of claim 10, further comprising providing a recording of the play from an elevated position and allowing the display of the elevated recording on the monitor.

19. The computer program product of claim 16, wherein the pre-recorded sporting play is a football play.

20. The method of claim 1, wherein the recorded sporting plays are football plays.

21. The method of claim 1, wherein the recording is made using a wide angle lens camera positioned behind the first player.

22. The computer program product of claim 10, wherein the pre-recorded plays are recorded using a wide angle lens camera positioned behind the first player.
